(19) United States
(12) Patent Application Publication
(10) Pub. No.: US 2009/0141232 A1
(43) Pub. Date: Jun. 4, 2009

(54) OPTICAL LENS MODULE

(75) Inventors: Rung-Sheng Cheng, Yunlin County (TW); Yu-Jen Wang, Taipei County (TW); Chien-Shien Yeh, Tainan County (TW); Chao-Chang Hu, Tainan City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 12/266,546

(22) Filed: Nov. 6, 2008

(30) Foreign Application Priority Data
Dec. 4, 2007 (TW) 96146136

(51) Int. Cl. G02F 1/1333; G02F 1/13; G02B 15/04

(52) U.S. Cl. 349/200; 359/676

(57) ABSTRACT

An optical lens module includes a support frame, a liquid crystal lens group, and a aberration compensation lens group. The aberration compensation lens compensates aberrations generated by the liquid crystal lenses. The liquid crystal lens group and the fixed aberration compensation lens group are disposed on the same optical axis. The optical lens module is power-saving, easily assembling, and has a small volume, which is helpful for miniaturizing and thinning optical lens modules, and thus further helpful for miniaturizing and thinning small-size or portable devices.

### CROSS-REFERENCE TO RELATED APPLICATION

This application claims the priority benefit of Taiwan application serial no. 96146136, filed on Dec. 4, 2007. The entirety of the above-mentioned patent application is hereby incorporated by reference herein and made a part of specification.

### BACKGROUND OF THE INVENTION

1. Field of the Invention

The present invention generally relates to an optical lens module, in particular, to an optical lens module using liquid crystal lenses.

2. Description of Related Art

Mostly, a camera module is built in small-size or portable devices, for example, mobile phones and PDAs, etc, which is provided for a user to take pictures, to collect information in real time, or to make video communications. When taking a picture or making a video, the user usually must find a view depending upon the actual requirements, so the user requires a zooming function with a desirable imaging effect. Therefore, camera modules with optical zooming function have gradually replaced fixed-focus camera modules or fixed-focus camera modules with digital zooming function.

However, in the conventional camera modules with the optical zooming function, a lens group is moved by an actuator and a driving mechanism (a movable part) to change the focal length. On the other hand, as for the camera module, due to the structure of the actuator and the driving mechanism, the crash test is a great challenge in the product test.

### SUMMARY OF THE INVENTION

Accordingly, the present invention is directed to an optical lens module using liquid crystal lenses. The optical lens module has advantages of simplified structure, power-saving, easy assembling and small volume, which is helpful for miniaturizing and thinning optical lens modules, and thus further helpful for miniaturizing and thinning the small-size or portable devices.

The present invention provides an optical lens module, which includes a support frame, a fixed liquid crystal lens group, and a fixed aberration compensation lens group. Each fixed liquid crystal lens group includes at least one liquid crystal lens and is fixed on the support frame. The fixed aberration compensation lens group includes at least one aberration compensation lens and is fixed on the support frame, and the aberration compensation lens compensates an aberration generated by the liquid crystal lenses. The fixed liquid crystal lens group and the fixed aberration compensation lens group are disposed on the same optical axis.

In the optical lens module, the aberration compensation lens is a lens with a constant refraction index.

In the optical lens module, the fixed liquid crystal lens group may provide functions of zooming or focusing.

In the optical lens module, each fixed liquid crystal lens group further includes a variable voltage source connected to the liquid crystal lens to provide a variable voltage to the liquid crystal lens, so as to change a refraction index of the liquid crystal lens, and thereby changing a focal length of the liquid crystal lens.

In the optical lens module, the liquid crystal lens includes a first transparent substrate and a second transparent substrate, a liquid crystal, a transparent spherical shell layer, and two transparent conductive films. The first transparent substrate and the second transparent substrate are stacked together and spaced apart by a certain interval. The liquid crystal is sealed between the first transparent substrate and the second transparent substrate. The transparent spherical shell layer is placed on one surface of the first transparent substrate. The two transparent conductive films are respectively attached to the transparent spherical shell layer and the second transparent substrate.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic side sectional view of an optical lens module according to a first embodiment of the present invention, in which a dot dash line indicates an optical axis of the optical lens module.

FIG. 2 is a schematic side sectional view of a liquid crystal lens according to the first embodiment of the present invention.

FIG. 3 is a schematic top view of an arrangement of liquid crystal molecules of the liquid crystals of the liquid crystal lens according to the first embodiment of the present invention before a voltage is applied (V=0).

FIG. 4 is a schematic top view of an arrangement of liquid crystal molecules of the liquid crystals of the liquid crystal lens according to the first embodiment of the present invention after a voltage is applied (V#0).

FIG. 5 is a curve diagram of deflection angle distribution of the liquid crystal molecules calculated through a commercial optical simulation software DIMOS under different driving voltages (focal length of the liquid crystal lens).

FIG. 6 is a schematic side sectional view of an optical lens module according to a second embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

### Embodiment 1

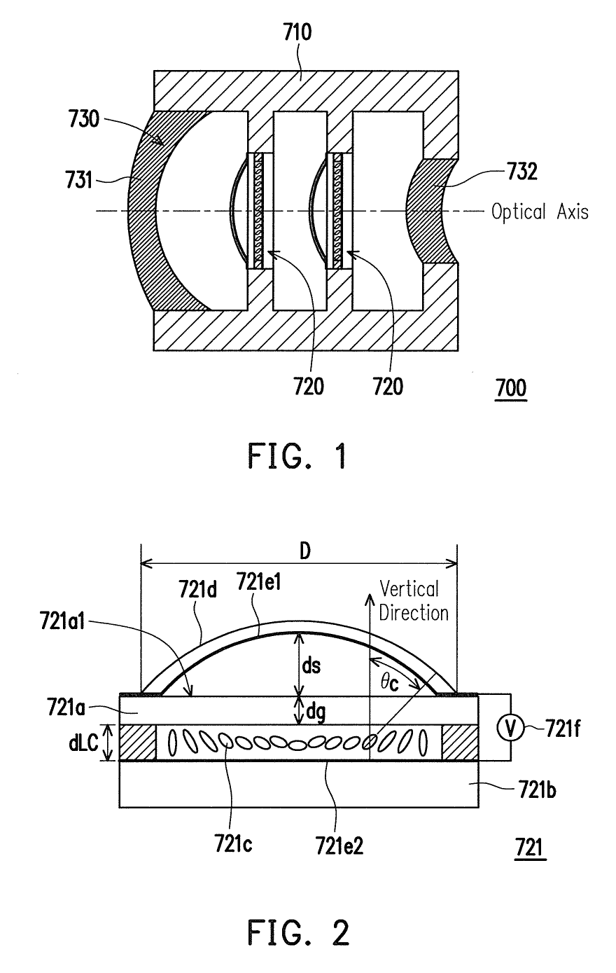

Referring to FIGS. 1 and 2, FIG. 1 is a schematic side sectional view of an optical lens module according to a first embodiment of the present invention, in which a dot dash line indicates an optical axis of the optical lens module, and FIG. 2 is a schematic side sectional view of a liquid crystal lens according to the first embodiment of the present invention.

As shown in FIG. 1, an optical lens module 700 includes a support frame 710, two fixed liquid crystal lens groups 720, 720, and a fixed aberration compensation lens group 730.

The support frame 710 may be any kind of support frames as long as it is capable of fixing the fixed liquid crystal lens groups 720 and the fixed aberration compensation lens group and enabling light rays to enter there through, for example, as shown in the drawing, it is a rectangular case with one circular hole respectively formed on a front end surface and a back end surface (i.e., left end surface and right end surface in the drawing), and each circular hole is used to dispose the fixed aberration compensation lens group 730. The support frame 710 may also be merely a bracket.

Each fixed liquid crystal lens group 720 includes at least one (for example, one) liquid crystal lens 721 and is fixed on the support frame 710.

The fixed aberration compensation lens group 730 includes at least one (for example, two) aberration compensation lenses 731, 732, and is fixed on the support frame 710, and the aberration compensation lenses 731, 732 are lenses with a constant refraction index. The two aberration compensation lenses 731, 732 are used to compensate aberrations generated by the two liquid crystal lenses 721, 721. The two fixed liquid crystal lens groups 720, 720 and the fixed aberration compensation lens group 730 are disposed on the same optical axis. In FIG. 1, although two aberration compensation lenses are shown, one aberration compensation lens may also be used to compensate the aberrations generated by two liquid crystal lenses 721, 721.

As shown in FIG. 2, each liquid crystal lens 721 includes a first transparent substrate 721a and a second transparent substrate 721b, a liquid crystal 721c, a transparent spherical shell layer 721d, two transparent conductive films 721e1, 721e2, and a variable voltage source 721f.

The first transparent substrate 721a and the second transparent substrate 721b are in the shape of flat plate and they are mutually stacked together and spaced apart by an interval dLC. The liquid crystal 721c is sealed between the first transparent substrate 721a and the transparent substrate 721b. The liquid crystal molecules of the liquid crystal 721c may deflect at different angles under different electric fields.

The transparent spherical shell layer 721d is in the shape of spherical shell and placed on one surface 721a1 of the first transparent substrate 721a.

The first transparent substrate 721a, the second transparent substrate 721b, and the transparent spherical shell layer 721d may be made of any material, as long as the material is capable of making light rays to pass through, for example, glass or acrylic resin etc.

Two transparent conductive films 721e1, 721e2 are respectively attached to the transparent spherical shell layer 721d and the second transparent substrate 721b. Since the transparent spherical shell layer 721d is in the shape of spherical shell, and the second transparent substrate 721b is in the shape of flat plate, the two transparent conductive films 721e1, 721e2 are respectively in the shape of spherical shell and flat plate. The transparent conductive films 721e1 and 721e2 may be made of any material, as long as the material is capable of making light rays pass there through, for example, indium tin oxide (ITO) film.

The variable voltage source 721f is connected to the spherical-shaped transparent conductive film 721e1 and the flat-plate-shaped transparent conductive film 721e2. The variable voltage source 721f may apply an electric field to the liquid crystal 721c through the two transparent conductive films 721e1, 721e2, and the electric field applied to the liquid crystal 721 is distributed with a gradient change from the centre of the liquid crystal lens 721 to the peripheral part, through using the spherical-shaped transparent conductive film 721e1 and the flat-plate-shaped transparent conductive film 721e2.

The transparent spherical shell layer 721d is used as a carrier for determining the shape of the transparent conductive film 721e1. The transparent spherical shell layer 721d may have any shape, as long as the shape is capable of making an electric field with a specific distribution be generated between the transparent conductive film 721e1 and the transparent conductive film 721e2, for example, a spherical shape. Furthermore, as described above, the electric field with the specific distribution is an electric field having a distribution with a gradient change from the centre of the liquid crystal lens 721 to the peripheral part.

In an experimental example of the liquid crystal lens 721 according to the present invention, a diameter (D) of the liquid crystal lens 721 is 6 mm, a thickness (dg) of the first transparent substrate 721a is 0.11 mm, and the interval (a thickness of the liquid crystal layer dLC) between the first transparent substrate 721a and the second transparent substrate 721b is 25 μm. The liquid crystal 721c adopted is a liquid crystal of No. LC BL-038. A height (ds) of the transparent spherical shell layer 721d is 0.26 mm. A driving voltage of the variable voltage source 721f is 35.4 Vrms, and a focusing scope thereof is 66.2 cm˜∞.

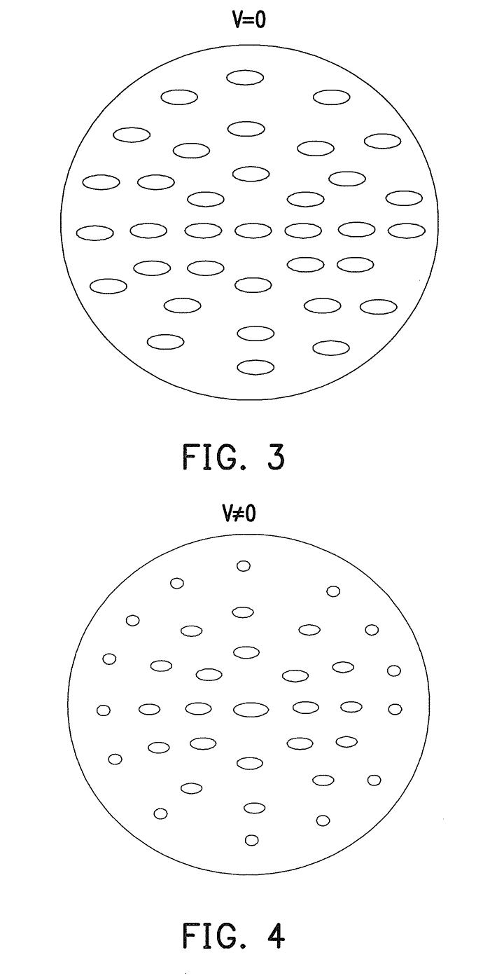

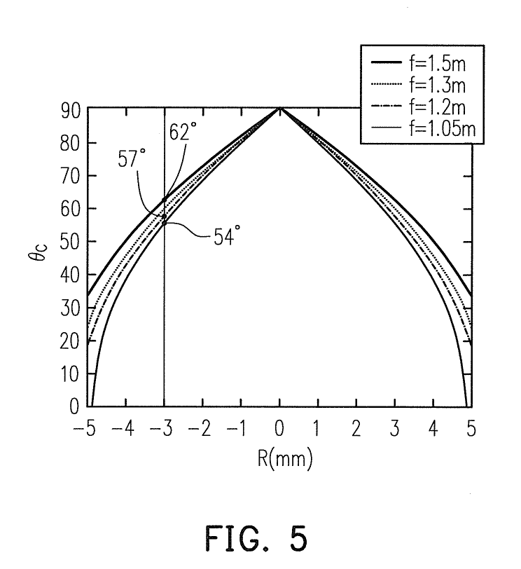

Then, the functions of the liquid crystal lens 721 generated as the changing of the driving voltage are illustrated. FIG. 3 is a schematic top view of an arrangement of liquid crystal molecules before a voltage is applied to the liquid crystal lens (V=0) according to the first embodiment of the present invention, FIG. 4 is a schematic top view of an arrangement of liquid crystal molecules after a voltage is applied to the liquid crystal lens (V≠0) according to the first embodiment of the present invention, and FIG. 5 is a curve diagram of deflection angle distribution of the liquid crystal molecules required by different focal lengths of the liquid crystal lens calculated through a commercial optical simulation software DIMOS.

Referring to FIGS. 2 and 3, when the voltage of the variable voltage source 721f is 0, the electric field applied on the liquid crystal 721c is 0, so the liquid crystal molecules of the liquid crystal 721c do not deflect (the deflection angle θc is 90 degrees), and thus, the distribution for the refraction index of the liquid crystal 721c is not changed, that is, the focal length of the liquid crystal lens 721 is not changed. Here, the deflection angle θc is an angle formed between a major axis of the liquid crystal molecules of the liquid crystal 721c and a vertical direction of the plate where the second transparent substrate 721b is located. Referring to FIGS. 2 and 4, once the variable voltage source 721f provides a voltage to two transparent conductive films 721e1 and 721e2, the electric filed having the distribution with a gradient change from the centre of the liquid crystal lens 721 to the peripheral part is applied on the liquid crystal 721c between the transparent conductive film 721e1 and the transparent conductive film 721e2, so the liquid crystal molecules of the liquid crystal 721c deflect for different angles (different deflection angles θc) according to the different electric fields (positions) applied thereon. Therefore, the distribution of the refraction index of the liquid crystal 721c is changed to a distribution with a gradient change from the centre of the liquid crystal lens 721 to the peripheral part, so as to achieve an effect of a lens with a specific focal length. Furthermore, as the driving voltage applied to the transparent conductive films 721e1 and 721e2 is changed, the distribution of the refraction index of the liquid crystal lens 721 may be changed, so as to achieve an effect of a lens with another specific focal length. That is, the liquid crystal lens can simulate the lens with the specific focal length by adjusting the driving voltage. The focal length changed as the changing of the driving voltage is called the focal length f of the liquid crystal lens.

According to the liquid crystal relevant parameters and structure relevant parameters of the liquid crystal lens 721, the optical simulation software DIMOS calculates the focal length of the liquid crystal lens 721 from the distribution of various deflection angles for the liquid crystal molecules.

Referring to FIG. 5, θc at the longitudinal axis represents the deflection angles of the liquid crystal molecules, and R at the transverse axis represents a distance between the liquid crystal molecules and the centre of the lens. For example, if the voltage applied to the variable voltage source 721f is V1 (not shown), the distribution of the deflection angles θc of the liquid crystal molecules is the uppermost curve (indicated by dark black solid line). At this time, the deflection angle θc of the liquid crystal molecules is about 35 degrees at a circumference (R=−5 mm or 5 mm) of the liquid crystal lens 721, about 62 degrees at a position of R=−3 mm or 3 mm, and about 90 degrees at the centre point (R=0 mm), and the focal length f of the liquid crystal lens 721 is 1.5 m (f2). If the voltage applied to the variable voltage source 721f is V2 (not shown), the distribution of the deflection angles θc of the liquid crystal molecules is one of the curves at the middle part (indicated by the dot dash line). At this time, the deflection angle θc of the liquid crystal molecules is about 20 degrees at the circumference of the liquid crystal lens 721, about 57 degrees at a position of R=−3 mm or 3 mm, and about 90 degrees at the centre point, and the focal length f of the liquid crystal lens 721 is 1.2 m (f2). If the voltage applied to the variable voltage source 721f is V3 (not shown), the distribution of the deflection angles θc of the liquid crystal molecules is the lowermost curve (indicated by the light black solid line). At this time, the deflection angle θc of the liquid crystal molecules is about 0 degrees at the circumference of the liquid crystal lens 721, about 54 degrees at a position of R=−3 mm or 3 mm, and about 90 degrees at the centre point, and the focal length f of the liquid crystal lens 721 is 1.05 m (f3). Therefore, the focal lengths (f1, f2, and f3) of the liquid crystal lens 721 can be changed simply by adjusting the driving voltages (V1, V2, and V3) of the variable voltage source 721f.

Then, referring to FIG. 1, the functions of the optical lens module 700 having the above structure according to the present invention are illustrated. For example, when finding a view, a driving voltage is applied to one fixed liquid crystal lens group 720 through the variable voltage source 721f, so as to change the distribution of the refraction index of the fixed liquid crystal lens group 720, thereby changing the focal length of the fixed liquid crystal lens group 720, and thus enlarging or reducing the image of the view to achieve the zooming function. When it finishes finding the view, according to the focal length of the fixed liquid crystal lens group 720, a driving voltage is applied to the other fixed liquid crystal lens group 720 through the variable voltage source 721f of the other fixed liquid crystal lens group 720, so as to change the distribution of the refraction index of the other fixed liquid crystal lens group 720, thereby changing the focal length of the other fixed liquid crystal lens group 720, and thus making the image of the selected view be clear to achieve the focusing function.

### Embodiment 2

In the above embodiment, an example of two fixed liquid crystal lens groups is shown, one of the fixed liquid crystal lens groups is used for zooming, and the other fixed liquid crystal lens group is used for focusing, so as to form the optical lens module having both zooming and focusing functions. However, the present invention is not limited to this, but merely one fixed liquid crystal lens group may also be used for the focusing function, so as to form an optical lens module having the focusing function.

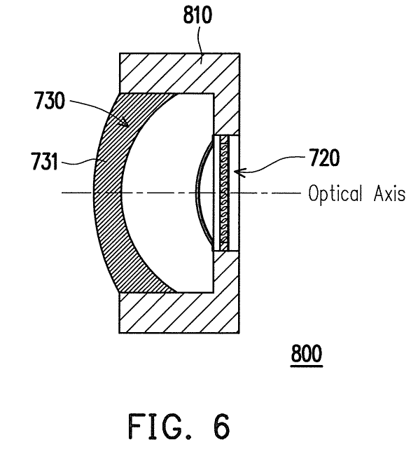

Referring to FIG. 6, it is a schematic side sectional view of an optical lens module to form an optical lens module of the present invention. Therefore, elements in FIG. 6 the same as that of other drawings are indicated by the same reference numbers, which thus will not be described here again.

The optical lens module in the second embodiment of the present invention is used as an optical lens module having the focusing function. The difference between the optical lens module 800 of this embodiment and that of the first embodiment lies in that only one fixed liquid crystal lens group is used.

One fixed liquid crystal lens group 720 is disposed on the support frame 810, and other structures and functions of the support frame 810 are the same as that of the support frame 710 in the first embodiment, which thus will not be described here again.

The optical lens module structure of the present invention does no have any movable part at all, which is different from the common optical lens module requiring movable parts, for example, movable lens groups, so the optical lens module of the present invention has a simplified structure, and it is power-saving, easily assembling, and has a small volume, which is helpful for miniaturizing and thinning optical lens modules, and thus further helpful for miniaturizing and thinning small-size or portable devices.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An optical lens module, comprising:
a support frame;
a fixed zoom lens group, comprising at least one zoom liquid crystal lens, fixed on the support frame;
a fixed focus lens group, comprising at least one focus liquid crystal lens, fixed on the support frame; and
a fixed aberration compensation lens group, comprising at least one aberration compensation lens, fixed on the support frame, wherein the aberration compensation lens compensates an aberration generated by the zoom liquid crystal lens, and an aberration generated by the focus liquid crystal lens,
wherein the fixed zoom lens group, the fixed focus lens group, and the fixed aberration compensation lens group are disposed on a same optical axis.

2. The optical lens module according to claim 1, wherein the aberration compensation lens is a lens with a constant refraction index.

3. The optical lens module according to claim 1, wherein the zoom liquid crystal lens further comprises a variable voltage source connected to the zoom liquid crystal lens to provide a variable voltage to the zoom liquid crystal lens, so as to change a refraction index of the zoom liquid crystal lens, thereby changing a focal length of the zoom liquid crystal lens.

4. The optical lens module according to claim 1, wherein the focus liquid crystal lens further comprises a variable voltage source connected to the focus liquid crystal lens to provide a variable voltage to the focus liquid crystal lens, so as to change a refraction index of the focus liquid crystal lens, thereby changing a focal length of the focus liquid crystal lens.

5. An optical lens module, comprising:
a support frame;
at least one fixed liquid crystal lens group, wherein each fixed liquid crystal lens group comprises at least one liquid crystal lens and is fixed on the support frame; and
a fixed aberration compensation lens group, comprising at least one aberration compensation lens connected to the support frame, wherein the aberration compensation lens compensates aberrations generated by the liquid crystal lenses,
wherein the fixed liquid crystal lens group and the fixed aberration compensation lens group are disposed on a same optical axis.

6. The optical lens module according to claim 5, wherein the aberration compensation lens is a lens with a constant refraction index.

7. The optical lens module according to claim 5, wherein at least one lens in the fixed liquid crystal lens group is used for zooming or focusing.

8. The optical lens module according to claim 5, wherein each fixed liquid crystal lens group further comprises a variable voltage source connected to the liquid crystal lens to provide a variable voltage to the liquid crystal lens, so as to change a refraction index of the liquid crystal lens, and thereby changing a focal length of the liquid crystal lens.

9. The optical lens module according to claim 5, wherein the liquid crystal lens comprises:
a first transparent substrate and a second transparent substrate, stacked together and spaced apart by an interval;
a liquid crystal, sealed between the first transparent substrate and the second transparent substrate;
a transparent spherical shell layer, placed on a surface of the first transparent substrate; and
two transparent conductive films, respectively attached to the transparent spherical shell layer and the second transparent substrate.

10. The optical lens module according to claim 9, wherein a diameter of the liquid crystal lens is 6 mm, the interval between the first transparent substrate and the second transparent substrate is 25 μm, a height of the transparent spherical shell layer is 0.26 mm, and a thickness of the first transparent substrate is 0.11 mm.

11. An optical lens module, comprising:
a support frame;
a fixed liquid crystal lens group, comprising at least one liquid crystal lens, fixed on the support frame; and
a fixed aberration compensation lens group, comprising at least one aberration compensation lens, fixed on the support frame, wherein the aberration compensation lens compensates aberrations generated by the liquid crystal lenses,
wherein the fixed liquid crystal lens group and the fixed aberration compensation lens group are disposed on a same optical axis.

12. The optical lens module according to claim 11, wherein the aberration compensation lens is a lens with a constant refraction index.

13. The optical lens module according to claim 11, wherein each fixed liquid crystal lens group further comprises a variable voltage source connected to the liquid crystal lens to provide a variable voltage to the liquid crystal lens, so as to change a refraction index of the liquid crystal lens, and thereby changing a focal length of the liquid crystal lens.

14. The optical lens module according to claim 11, wherein the liquid crystal lens comprises:
a first transparent substrate and a second transparent substrate, stacked together and spaced apart by an interval;
a liquid crystal, sealed between the first transparent substrate and the second transparent substrate;
a transparent spherical shell layer, placed on a surface of the first transparent substrate; and
two transparent conductive films, respectively attached to the transparent spherical shell layer and the second transparent substrate.

15. The optical lens module according to claim 14, wherein a diameter of the liquid crystal lens is 6 mm, the interval between the first transparent substrate and the second transparent substrate is 25 μm, a height of the transparent spherical shell layer is 0.26 mm, and a thickness of the first transparent substrate is 0.11 mm.
